(19) United States
(12) Patent Application Publication
(10) Pub. No.: US 2024/0105410 A1
(43) Pub. Date: Mar. 28, 2024

(54) HYBRID ELECTRICALLY AND THERMALLY SWITCHABLE SYSTEM USING HEAT SOURCE

(71) Applicant: Meta Platforms Technologies, LLC, Menlo Park, CA (US)

(72) Inventors: Afsoon Jamali, Issaquah, WA (US); Arman Boromand, Issaquah, WA (US); Gareth John Valentine, Kirkland, WA (US); Martin Schubert, Mountain View, CA (US); Paul Murray LeFebvre, Brookings, OR (US); Francis Lawrence Leard, Sudbury, MA (US); Olga Vladimirovna Barykina-Tassa, San Mateo, CA (US)

(21) Appl. No.: 18/476,286

(22) Filed: Sep. 27, 2023

Related U.S. Application Data
(60) Provisional application No. 63/410,432, filed on Sep. 27, 2022.

(51) Int. Cl. H01H 61/013; G02B 27/01; G02F 1/13; H01H 61/02

(52) U.S. Cl. CPC H01H 61/013; G02B 27/0172; G02F 1/132; H01H 61/02; G02B 2027/0118

(57) ABSTRACT

An optical device includes a first optically dimmable switch for providing a first transmittance while the first optically dimmable switch is in a first state and providing a second transmittance distinct from the first transmittance while the first optically dimmable switch is in a second state distinct from the first state. The optical device also includes a dynamic heat source thermally coupled with the first optically dimmable switch. The dynamic heat source is at a first temperature at a first time and is at a second temperature distinct from the first temperature at a second time mutually exclusive from the first time. The optical device may operate as an optical dimming device, which may be used in head-mounted display devices or as dimmable windows or shutters.

### RELATED APPLICATIONS

This application claims the benefit of, and priority to, U.S. Provisional Patent Application Ser. No. 63/410,432, entitled “Hybrid Electric and Thermo Switchable System Using Heat Source” filed Sep. 27, 2022, which is incorporated by reference herein in its entirety.

### TECHNICAL FIELD

The present disclosure relates generally to optical devices and, more specifically, to optical devices that provides dimming effects based on heat sources.

### BACKGROUND

Optical devices are widely used in optical applications. By providing the ability to modulate light based on applied electrical signals, optical devices can be used, for example, to switch on or off transmission of light. Additionally or alternatively, optical devices can be used to modify optical properties of light, such as polarization or spectral power distribution.

### SUMMARY

However, there is a need for improving a transition speed (e.g., a speed in switching from an “on” state to an “off” state or from the “off” state to the “on” state) and the stability of optical devices. In addition, an increased contrast between the “on” state and the “off” state is desired in certain applications.

This application describes optical devices that utilize heat sources for facilitating the switching between the “on” state and the “off” state. The disclosed devices may be operated at a high speed while providing a high contrast between the “on” state and the “off” state.

In accordance with some embodiments, an optical device includes a first optically dimmable switch for providing a first transmittance while the first optically dimmable switch is in a first state and providing a second transmittance distinct from the first transmittance while the first optically dimmable switch is in a second state distinct from the first state. The optical device also includes a dynamic heat source thermally coupled with the first optically dimmable switch. The dynamic heat source is at a first temperature at a first time and is at a second temperature distinct from the first temperature at a second time mutually exclusive from the first time.

In some embodiments, the dynamic heat source at the first temperature places the first optically dimmable switch in the first state, and the dynamic heat source at the second temperature places the first optically dimmable switch in the second state.

In some embodiments, the optical device further includes a second optically dimmable switch that is optically coupled with the first optically dimmable switch so that a ray of light passes through the first optically dimmable switch and the second optically dimmable switch sequentially.

In some embodiments, the first optically dimmable switch includes photochromic material.

In some embodiments, the second optically dimmable switch includes liquid crystal.

In some embodiments, the first optically dimmable switch includes photodichroic material.

In some embodiments, the first optically dimmable switch also includes liquid crystal.

In some embodiments, the first optically dimmable switch includes carbon nanotubes.

In some embodiments, the optical device includes an array of optically dimmable switches, including the first optically dimmable switch.

In accordance with some embodiments, a head-mounted display device includes a display and an optical device that includes: a first optically dimmable switch for providing a first transmittance while the first optically dimmable switch is in a first state and providing a second transmittance distinct from the first transmittance while the first optically dimmable switch is in a second state distinct from the first state; and a dynamic heat source thermally coupled with the first optically dimmable switch. The dynamic heat source is at a first temperature at a first time and is at a second temperature distinct from the first temperature at a second time mutually exclusive from the first time.

In some embodiments, the dynamic heat source at the first temperature places the first optically dimmable switch in the first state, and the dynamic heat source at the second temperature places the first optically dimmable switch in the second state.

In some embodiments, the optical device further includes a second optically dimmable switch that is optically coupled with the first optically dimmable switch so that a ray of light passes through the first optically dimmable switch and the second optically dimmable switch sequentially.

In some embodiments, the first optically dimmable switch includes photochromic material.

In some embodiments, the second optically dimmable switch includes liquid crystal.

In some embodiments, the first optically dimmable switch includes photodichroic material.

In some embodiments, the first optically dimmable switch also includes liquid crystal.

In some embodiments, the first optically dimmable switch includes carbon nanotubes.

In some embodiments, the head-mounted display device includes an array of optically dimmable switches, including the first optically dimmable switch.

In accordance with some embodiments, a method includes: at a first time, setting a dynamic heat source thermally coupled with a first optically dimmable switch to be at a first temperature so that the first optically dimmable switch enters a first state for providing a first transmittance; and, at a second time mutually exclusive from the first time, setting the dynamic heat source to be at a second temperature distinct from the first temperature so that the first optically dimmable switch enters a second state for providing a second transmittance distinct from the first transmittance.

In some embodiments, the second time is subsequent to the first time. The method further includes, at a third time subsequent to the second time, setting the dynamic heat source to be at a third temperature distinct from the first temperature and the second temperature so that the first optically dimmable switch enters a third state for providing a third transmittance distinct from the first transmittance and the second transmittance.

The disclosed optical devices and methods may replace conventional optical devices and methods. The disclosed optical devices and methods may complement conventional optical devices and methods.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIGS. 1A-1C are schematic diagrams illustrating optical devices in accordance with some embodiments.

FIGS. 2A and 2B are schematic diagrams illustrating optical devices in accordance with some embodiments.

FIG. 3 is a schematic diagram illustrating an optical device in accordance with some embodiments.

FIG. 4 is a schematic diagram illustrating an optical device in accordance with some embodiments.

FIG. 5 is a perspective view of a display device in accordance with some embodiments.

FIG. 6 is a block diagram of a system including a display device in accordance with some embodiments.

FIG. 7 is an isometric view of a display device in accordance with some embodiments.

These figures are not drawn to scale unless indicated otherwise.

### DETAILED DESCRIPTION

As described above, conventional optical devices have limited transition speed and stability. The optical devices described herein provide fast transition speed and long-term stability.

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

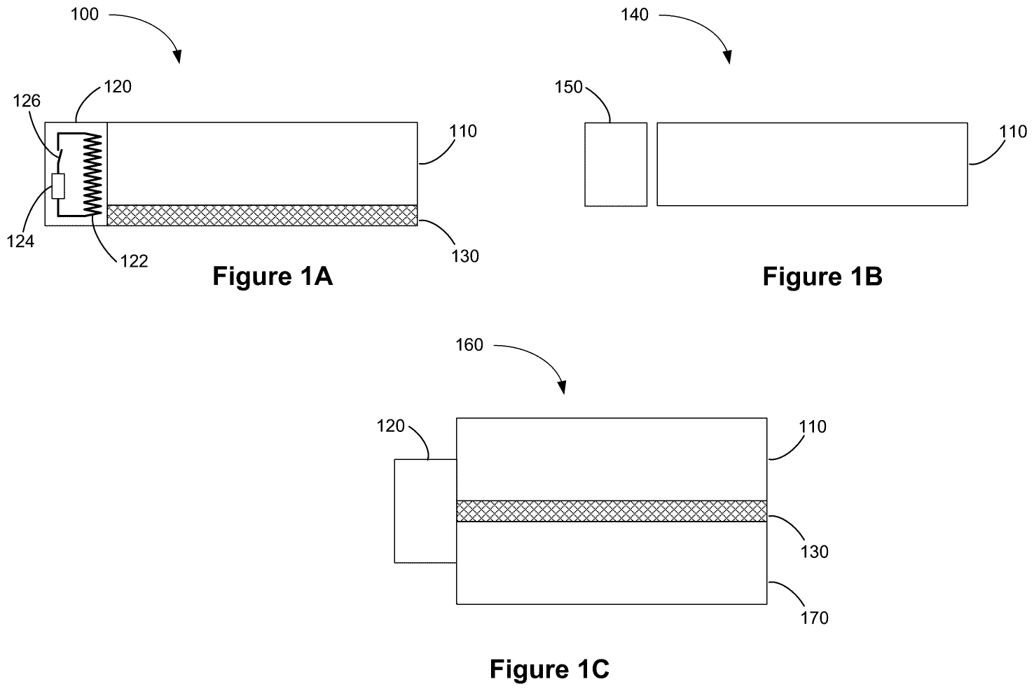

FIGS. 1A-1C are schematic diagrams illustrating different states of an optical device in accordance with some embodiments.

FIG. 1A illustrates an optical device 100 that includes an optically dimmable switch 110 and a dynamic heat source 120.

The optically dimmable switch 110 may be operated in two or more states (e.g., an “on” state and an “off” state). The optically dimmable switch 110 provides (i) a first transmittance (e.g., a high transmittance, such as 100%, 99.9%, 99%, 98%, 97%, 96%, 95%, 90%, 85%, 80%, 75%, 70%, 65%, 60%, 55%, or 50%, or within an interval between any two of the aforementioned values) while the optically dimmable switch 110 is in a first state and (ii) a second transmittance (e.g., a low transmittance, such as 0%, 0.1%, 1%, 2%, 3%, 4%, 5%, 10%, 15%, 20%, 25%, 30%, 35%, 40%, 45%, or 49%, or within any interval between any two of the aforementioned values) while the optically dimmable switch 110 is in a second state.

In some embodiments, the optically dimmable switch 110 includes photochromic material. This allows the transmittance of the optically dimmable switch 110 to change in response to exposure of the photochromic material to light (e.g., ultraviolet light). In some embodiments, the optically dimmable switch 110 does not include photochromic material.

In some embodiments, the optically dimmable switch 110 includes photodichroic material. In some embodiments, the optically dimmable switch 110 does not include photodichroic material.

In some embodiments, the optically dimmable switch 110 includes thermochromic material. This allows the transmittance of the optically dimmable switch 110 to change in response to a change in a temperature of the optically dimmable switch 110 (or the thermochromic material in the optically dimmable switch 110). In some embodiments, the optically dimmable switch 110 does not include thermochromic material.

The dynamic heat source 120 may be operated in two or more states (e.g., an “on” state and an “off” state, which may or may not be independent of the state the optically dimmable switch 110). In some configurations, the dynamic heat source 120 does not provide heat while the dynamic heat source 120 is in the “off” state and the dynamic heat source 120 provides heat while the dynamic heat source 120 is in the “on” state.

In some embodiments, the dynamic heat source 120 includes a resistive heater. For example, the dynamic heat source 120 may include a resistor 122, an electrical source 124 (e.g., a battery), and a switch 126. The resistor 122, the electrical source 124, and the switch 126 may be electrically connected so that when the switch 124 is closed, an electrical input from the electrical source 124 is provided to the resistor 122 to generate heat. When the switch 124 is opened, the resistor 122 ceases to generate heat. Other types of heaters may be used (e.g., thermo-electric heater, radiative heater, etc.).

The dynamic heat source 120 is thermally coupled with the optically dimmable switch 110. This allows the dynamic heat source 120 to change the temperature of the optically dimmable switch 110. For example, the dynamic heat source 120 may provide a high amount of thermal energy to the optically dimmable switch 110 to increase the temperature of the optically dimmable switch 110 at a high temperature, and the dynamic heat source 120 may provide a low amount of thermal energy (or no thermal energy) to the optically dimmable switch 110 to lower the temperature of the optically dimmable switch 110 (or return the temperature of the optically dimmable switch 110 from the increased temperature).

Changing the temperature of the optically dimmable switch 110 changes electrical and/or optical properties of the optically dimmable switch 110 (or electrical and/or optical properties of materials within the optically dimmable switch 110). For example, when the optically dimmable switch 110 includes a thermochromic material, changing the temperature of the optically dimmable switch 110 changes the color and/or transmittance of the optically dimmable switch 110 (or the thermochromic material within the optically dimmable switch 110). In another example, when the optically dimmable switch 110 includes a photochromic material, changing the temperature of the optically dimmable switch 110 changes a contrast (e.g., a ratio of transmittance values of the optically dimmable switch 110 in “on” and “off” states) of the optically dimmable switch 110 (or of the photochromic material). Thus, by selectively changing the temperature of the optically dimmable switch 10, the performance of the optically dimmable switch 110 can be enhanced.

In FIG. 1A, optical device 100 includes a thermally conductive material 130 (e.g., a layer of a thermally conductive material). In FIG. 1A, the thermally conductive material 130 is coupled with the optically dimmable switch 110 and the dynamic heat source 120. This allows the thermally conductive material 130 to facilitate transfer of the heat energy from the dynamic heat source 120 across the optically dimmable switch 110. In FIG. 1A, the dynamic heat source 120 is in direct contact with the optically dimmable switch 110. However, in some other configurations, the dynamic heat source 120 need not be in direct contact with the optically dimmable switch 110.

FIG. 1B illustrates an optical device 140 that includes an optically dimmable switch 110 and a dynamic heat source 150. The dynamic heat source 150 may be a radiative heater or a convective heater. When the dynamic heat source 150 is a radiative heater or a convective heater, the optical device 140 does not need the thermally conductive material 130 coupled with the optically dimmable switch 110. However, in some configurations, the optical device 140 may include the thermally conductive material 130 even when the dynamic heat source 150 includes a radiative heater or a convective heater (e.g., the dynamic heat source 150 may be a combination of (i) a conductive heater and (ii) a radiative heater or a convective heater, in which case the thermally conductive material 130 is used to transfer heat from the conductive heater to the optically dimmable switch 110, or the thermally conductive material 130 is used to facilitate spreading of the thermal energy across the optically dimmable switch 110 even when no conductive heater is used).

FIG. 1C illustrates an optical device 160, which is similar to the optical device 100 except that the optical device 160 also includes another optically dimmable switch 170 (e.g., the optically dimmable switch 110 may be called a first optically dimmable switch and the optically dimmable switch 170 may be called a second optically dimmable switch).

In FIG. 1C, the second optically dimmable switch 170 is coupled with the thermally conductive material 130 so that the thermal energy from the dynamic heat source 120 may be used to change the temperature of both the first optically dimmable switch 110 and the second optically dimmable switch 170.

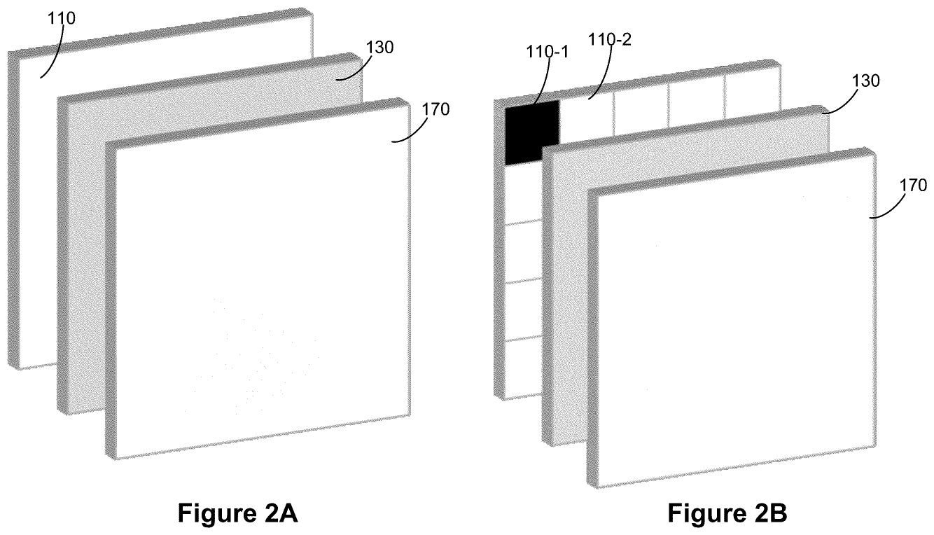

FIGS. 2A and 2B are schematic diagrams illustrating optical devices in accordance with some embodiments. In FIGS. 2A and 2B, optical devices are illustrated in exploded views to show components of such optical devices with clarity. Certain aspects of such optical devices (e.g., the dynamic heat source 120) are also omitted so as not to obscure other aspects of such optical devices.

The optical devices shown in FIGS. 2A and 2B include the first optically dimmable switch 110, the second optically dimmable switch 170, and the thermally conductive material 130.

In FIG. 2A, the optical device includes a single first optically dimmable switch 110. This allows the first optically dimmable switch 110 to adjust the transmittance across an aperture of the optical device. For example, the transmittance of the optical device may be uniform across the entire aperture of the optical device.

In FIG. 2B, the optical device includes an array of optically dimmable switches (e.g., optically dimmable switches 110-1 and 110-2). This allows the optical device to adjust the transmittance for only a portion, less than all, of the aperture of the optical device. For example, the optically dimmable switch 110-1 may be turned on while the optically dimmable switch 110-2 may be turned off so that regions corresponding to the optically dimmable switch 110-1 and the optically dimmable switch 110-2 have different transmittances. In some embodiments, respective optically dimmable switches in the array of optically dimmable switches are independently activatable (e.g., a particular optically dimmable switch may be turned on or off independently of whether the rest of the optically dimmable switches are turned on or off). In some embodiments, the array of optically dimmable switches are arranged as pixels across the aperture of the optical device. In some embodiments, each pixel has a shape of a square having a size of 1 mm×1 mm, although the pixel may have a different size or shape (e.g., the pixel may be bigger or smaller, wider or narrower, taller or shorter, and may have a square shape, a non-square rectangular shape, or any other shape).

In FIGS. 2A and 2B, each of the optical devices includes a single second optically dimmable switch 170. This allows the second optically dimmable switch 170 to adjust the transmittance across the aperture of the optical device. However, in some embodiments, the optical device includes an array of second optically dimmable switches. In some embodiments, the number of second optically dimmable switches and the number of first optically dimmable switches are identical. In some embodiments, the number of second optically dimmable switches and the number of first optically dimmable switches are different.

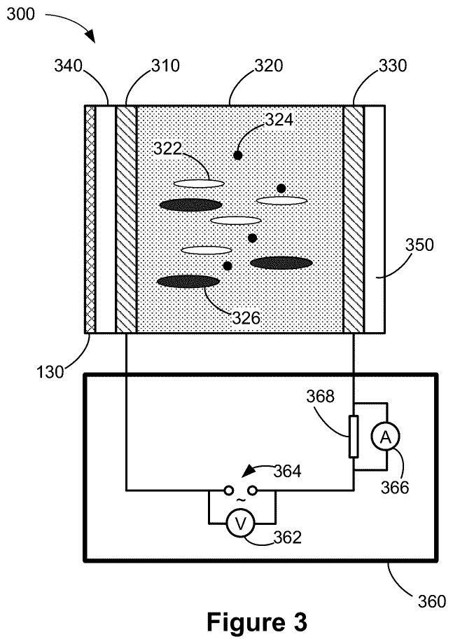

FIG. 3 is a schematic diagram illustrating an optical device 300 in accordance with some embodiments.

The optical device 300 includes a first electrode 310. The first electrode 310 may provide an electrical field to a medium 320 located adjacent to the first electrode 310.

FIG. 3 also shows that the optical device 300 includes a second electrode 330. In some embodiments, the second electrode 330 is distinct and separate from the first electrode 310.

FIG. 3 shows that the optical device 300 also includes a first substrate 340. In some embodiments, the first substrate 340 is located adjacent to the first electrode 310 (e.g., the first electrode 310 is located adjacent to the first substrate 340).

FIG. 3 also shows that the optical device 300 further includes a second substrate 350. In some embodiments, the second substrate 350 is located adjacent to the second electrode 330 (e.g., the second electrode 330 is also located adjacent to the second substrate 350). In some embodiments, the second substrate 350 is distinct and separate from the first substrate 340. This allows the first substrate 340 and the second substrate 350 to define a cavity between the first substrate 340 and the second substrate 350. As shown in FIG. 3, in some configurations, the medium 320 is located in the cavity.

In some embodiments, the medium 320 includes one or more molecules or structures. In some embodiments, the medium 320 includes liquid crystals 322. In some embodiments, the medium 320 includes dye molecules (e.g., dichroic dye molecules, photodichroic dye molecules, etc.). In some embodiments, the medium 320 includes a combination of liquid crystals 322 and dye molecules 324. In some embodiments, the medium 320 includes a combination of dichroic dye-doped liquid crystals 326 and photodichroic dye. In some embodiments, the liquid crystals are or include nematic liquid crystals. In some embodiments, the liquid crystals are or include twist-bend chiral nematic liquid crystals. In some embodiments, the liquid crystals are or include dichroic dye-doped twist-bend chiral nematic liquid crystals. In some embodiments, the medium 320 includes carbon nanotubes.

In some embodiments, the optical device 300 is electrically coupled with an electrical source 360. The electrical source 360 may provide a voltage or current to the optical device 300 (e.g., across or between the first electrode 310 and the second electrode 330). For example, in some embodiments, the first electrode 310 and the second electrode 330 are electrically coupled with the electrical source 360. In some embodiments, the optical device 300 includes the electrical source 360. In some embodiments, the electrical source 360 is not part of the optical device 300.

As shown in FIG. 3, in some embodiments, the electrical source 360 includes one or more voltage sources 362 and 364. In some embodiments, the electrical source 360 includes one or more current sources 366. In some embodiments, the electrical source 360 includes one or more voltage sources 362 and 364 and one or more current sources 366. In some embodiments, the electrical source 360 includes one or more voltage sources 362 and 364 without one or more current sources 366. In some embodiments, the electrical source 360 includes one or more current sources 366 without one or more voltage sources 362 and 364.

In some embodiments, the electrical source 360 includes an electrical power storage (e.g., a battery or a capacitor).

As shown in FIG. 3, in some embodiments, the one or more current sources 366 are electrically connected in parallel to one or more impedances 368 (e.g., resistors). In some embodiments, one or more current sources are electrically connected in series.

As shown in FIG. 3, in some embodiments, the one or more voltage sources 362 and 364 are electrically connected in parallel (e.g., the voltage source 362 is electrically connected in parallel to the voltage source 364). In some embodiments, the one or more voltage sources 362 and 364 include a direct-current voltage source. In some embodiments, the one or more voltage sources 362 and 364 include an alternating-current voltage source (or a dynamic voltage source that provides voltages in a non-sinusoidal pattern). In some embodiments, the one or more voltage sources 362 and 364 include both a direct-current voltage source and an alternating-current voltage source (or a dynamic voltage source).

In some embodiments, the electrical source 360 provides a first electrical input V1 (e.g., a zero-voltage input or an electrical input below a predefined electrical threshold, such as a voltage threshold) across the first electrode 310 and the second electrode 330 at a first time. Such electrical input does not cause rearrangement of molecules or structures within the medium 320. As a result, the optical device 300 may have a first transmittance. In some embodiments, the electrical source 360 provides a second electrical input V2 (e.g., a non-zero voltage input or an electrical input above the predefined electrical threshold, such as the voltage threshold) across the first electrode 310 and the second electrode 330 at a second time. Such electrical input causes rearrangement of molecules or structures within the medium 320. As a result, the optical device 300 may have a second transmittance that is different from the first transmittance.

FIG. 3 also shows that the optical device 300 includes a thermally conductive material 130. In some embodiments, the thermally conductive material 130 is coupled with a dynamic heat source (e.g., the dynamic heat source 120 or 150 described with respect to FIGS. 1A-1C).

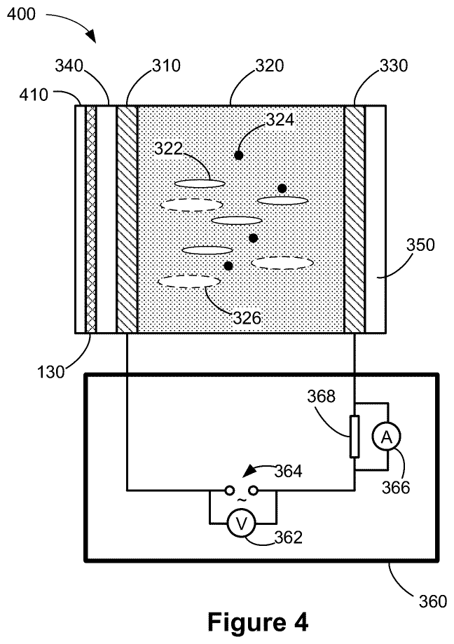

FIG. 4 is a schematic diagram illustrating an optical device 400 in accordance with some embodiments. The optical device 400 is similar to the optical device 300 described with respect to FIG. 3, except that the optical device 400 includes a layer of photochromic material 410 coupled with the thermally conductive material 130. The layer of photochromic material 410 changes color and/or transmittance when the layer of photochromic material 410 is exposed to light (e.g., ultraviolet light). By changing the temperature of the layer of photochromic material 410, the optical properties of the photochromic material 410 may be further adjusted.

Although FIGS. 3 and 4 illustrate optical devices with a single optically dimmable switch, in some embodiments, the optical device includes a stack of two or more optically dimmable switches.

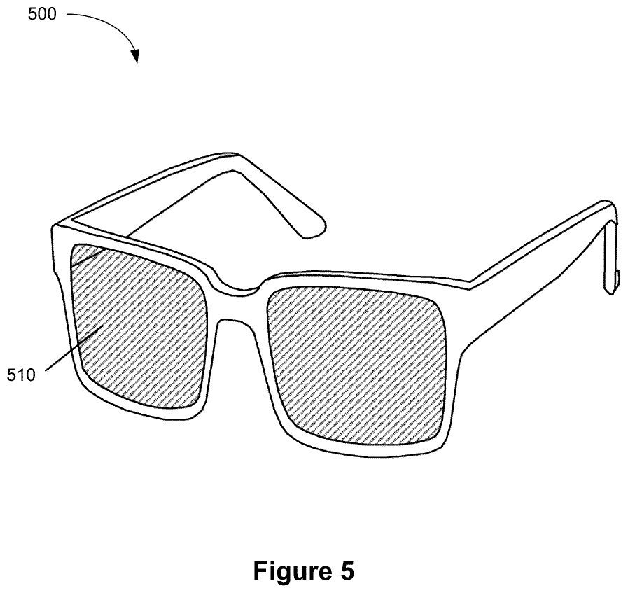

In some embodiments, an optical device (e.g., 100) may be used in display devices such as head-mounted display devices. In some embodiments, an optical device (e.g., 100) may be implemented as multifunctional optical components in near-eye displays for augmented reality (“AR”), virtual reality (“VR”), and/or mixed reality (“MR”). For example, the disclosed optical elements or devices may be implemented as optical dimming elements (e.g., variable intensity filters), etc., which may significantly reduce the weight and size, and enhance the optical performance of the head-mounted display devices. Exemplary embodiments of head-mounted display devices for implementing an optical device (e.g., 100) are described with respect to FIGS. 5-7.

FIG. 5 illustrates display device 500 in accordance with some embodiments. In some embodiments, display device 500 is configured to be worn on a head of a user (e.g., by having the form of spectacles or eyeglasses, as shown in FIG. 5) or to be included as part of a helmet that is to be worn by the user. When display device 500 is configured to be worn on a head of a user or to be included as part of a helmet, display device 500 is called a head-mounted display. Alternatively, display device 500 is configured for placement in proximity of an eye or eyes of the user at a fixed location, without being head-mounted (e.g., display device 500 is mounted in a vehicle, such as a car or an airplane, for placement in front of an eye or eyes of the user). As shown in FIG. 5, display device 500 includes display 510. Display 510 is configured for presenting visual contents (e.g., augmented reality contents, virtual reality contents, mixed reality contents, or any combination thereof) to a user.

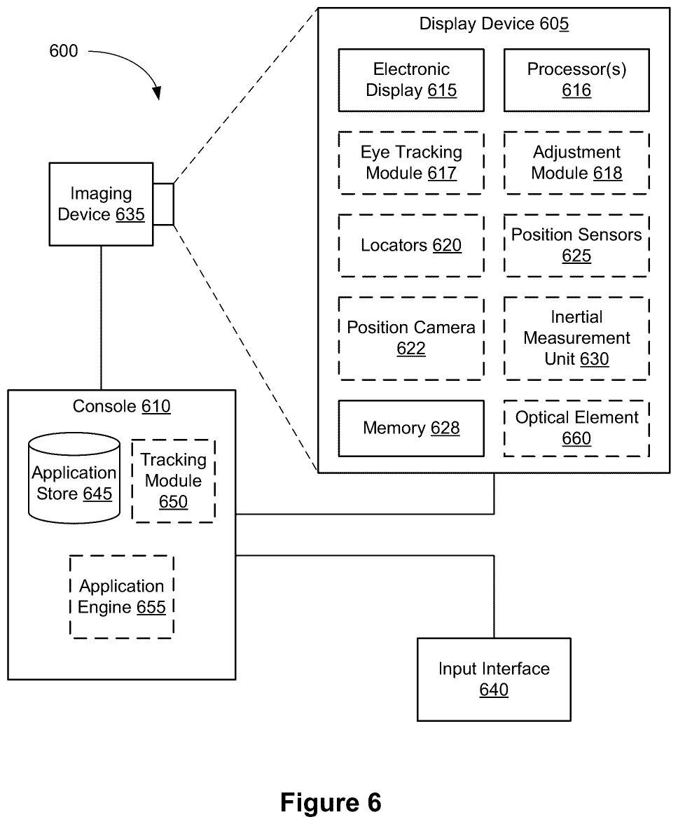

In some embodiments, display device 500 includes one or more components described herein with respect to FIG. 6. In some embodiments, display device 500 includes additional components not shown in FIG. 6.

FIG. 6 is a block diagram of system 600 in accordance with some embodiments. The system 600 shown in FIG. 6 includes display device 605 (which corresponds to display device 500 shown in FIG. 5), imaging device 635, and input interface 640 that are each coupled to console 610. While FIG. 6 shows an example of system 600 including one display device 605, imaging device 635, and input interface 640, in other embodiments, any number of these components may be included in system 600. For example, there may be multiple display devices 605 each having associated input interface 640 and being monitored by one or more imaging devices 635, with each display device 605, input interface 640, and imaging devices 635 communicating with console 610. In alternative configurations, different and/or additional components may be included in system 600. For example, in some embodiments, console 610 is connected via a network (e.g., the Internet or a wireless network) to system 600 or is self-contained as part of display device 605 (e.g., physically located inside display device 605). In some embodiments, display device 605 is used to create mixed reality by adding in a view of the real surroundings. Thus, display device 605 and system 600 described here can deliver augmented reality, virtual reality, and mixed reality.

In some embodiments, as shown in FIG. 5, display device 605 is a head-mounted display that presents media to a user. Examples of media presented by display device 605 include one or more images, video, audio, or some combination thereof. In some embodiments, audio is presented via an external device (e.g., speakers and/or headphones) that receives audio information from display device 605, console 610, or both, and presents audio data based on the audio information. In some embodiments, display device 605 immerses a user in an augmented environment.

In some embodiments, display device 605 also acts as an augmented reality (AR) headset. In these embodiments, display device 605 augments views of a physical, real-world environment with computer-generated elements (e.g., images, video, sound, etc.). Moreover, in some embodiments, display device 605 is able to cycle between different types of operation. Thus, display device 605 operate as a virtual reality (VR) device, an augmented reality (AR) device, as glasses or some combination thereof (e.g., glasses with no optical correction, glasses optically corrected for the user, sunglasses, or some combination thereof) based on instructions from application engine 655.

Display device 605 includes electronic display 615, one or more processors 616, eye tracking module 617, adjustment module 618, one or more locators 620, one or more position sensors 625, one or more position cameras 622, memory 628, inertial measurement unit (IMU) 630, one or more optical elements 660 or a subset or superset thereof (e.g., display device 605 with electronic display 615, one or more processors 616, and memory 628, without any other listed components). Some embodiments of display device 605 have different modules than those described here. Similarly, the functions can be distributed among the modules in a different manner than is described here.

One or more processors 616 (e.g., processing units or cores) execute instructions stored in memory 628. Memory 628 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 628, or alternately the non-volatile memory device(s) within memory 628, includes a non-transitory computer readable storage medium. In some embodiments, memory 628 or the computer readable storage medium of memory 628 stores programs, modules and data structures, and/or instructions for displaying one or more images on electronic display 615.

Electronic display 615 displays images to the user in accordance with data received from console 610 and/or processor(s) 616. In various embodiments, electronic display 615 may comprise a single adjustable display element or multiple adjustable display elements (e.g., a display for each eye of a user). In some embodiments, electronic display 615 is configured to display images to the user by projecting the images onto one or more optical elements 660.

In some embodiments, the display element includes one or more light emission devices and a corresponding array of spatial light modulators. A spatial light modulator is an array of electro-optic pixels, opto-electronic pixels, some other array of devices that dynamically adjust the amount of light transmitted by each device, or some combination thereof. These pixels are placed behind one or more lenses. In some embodiments, the spatial light modulator is an array of liquid crystal based pixels in an LCD (a Liquid Crystal Display). Examples of the light emission devices include: an organic light emitting diode, an active-matrix organic light-emitting diode, a light emitting diode, some type of device capable of being placed in a flexible display, or some combination thereof. The light emission devices include devices that are capable of generating visible light (e.g., red, green, blue, etc.) used for image generation. The spatial light modulator is configured to selectively attenuate individual light emission devices, groups of light emission devices, or some combination thereof. Alternatively, when the light emission devices are configured to selectively attenuate individual emission devices and/or groups of light emission devices, the display element includes an array of such light emission devices without a separate emission intensity array. In some embodiments, electronic display 615 projects images to one or more reflective elements 660, which reflect at least a portion of the light toward an eye of a user.

One or more lenses direct light from the arrays of light emission devices (optionally through the emission intensity arrays) to locations within each eyebox and ultimately to the back of the user's retina(s). An eyebox is a region that is occupied by an eye of a user located proximity to display device 605 (e.g., a user wearing display device 605) for viewing images from display device 605. In some cases, the eyebox is represented as a 10 mm×10 mm square. In some embodiments, the one or more lenses include one or more coatings, such as anti-reflective coatings.

In some embodiments, the display element includes an infrared (IR) detector array that detects IR light that is retro-reflected from the retinas of a viewing user, from the surface of the corneas, lenses of the eyes, or some combination thereof. The IR detector array includes an IR sensor or a plurality of IR sensors that each correspond to a different position of a pupil of the viewing user's eye. In alternate embodiments, other eye tracking systems may also be employed. As used herein, IR refers to light with wavelengths ranging from 700 nm to 1 mm including near infrared (NIR) ranging from 750 nm to 1500 nm.

Eye tracking module 617 determines locations of each pupil of a user's eyes. In some embodiments, eye tracking module 617 instructs electronic display 615 to illuminate the eyebox with IR light (e.g., via IR emission devices in the display element).

A portion of the emitted IR light will pass through the viewing user's pupil and be retro-reflected from the retina toward the IR detector array, which is used for determining the location of the pupil. Alternatively, the reflection off of the surfaces of the eye is used to also determine location of the pupil. The IR detector array scans for retro-reflection and identifies which IR emission devices are active when retro-reflection is detected. Eye tracking module 617 may use a tracking lookup table and the identified IR emission devices to determine the pupil locations for each eye. The tracking lookup table maps received signals on the IR detector array to locations (corresponding to pupil locations) in each eyebox. In some embodiments, the tracking lookup table is generated via a calibration procedure (e.g., user looks at various known reference points in an image and eye tracking module 617 maps the locations of the user's pupil while looking at the reference points to corresponding signals received on the IR tracking array). As mentioned above, in some embodiments, system 600 may use other eye tracking systems than the embedded IR one described herein.

Adjustment module 618 generates an image frame based on the determined locations of the pupils. In some embodiments, this sends a discrete image to the display that will tile subimages together thus a coherent stitched image will appear on the back of the retina. Adjustment module 618 adjusts an output (i.e., the generated image frame) of electronic display 615 based on the detected locations of the pupils. Adjustment module 618 instructs portions of electronic display 615 to pass image light to the determined locations of the pupils. In some embodiments, adjustment module 618 also instructs the electronic display to not pass image light to positions other than the determined locations of the pupils. Adjustment module 618 may, for example, block and/or stop light emission devices whose image light falls outside of the determined pupil locations, allow other light emission devices to emit image light that falls within the determined pupil locations, translate and/or rotate one or more display elements, dynamically adjust curvature and/or refractive power of one or more active lenses in the lens (e.g., microlens) arrays, or some combination thereof.

Optional locators 620 are objects located in specific positions on display device 605 relative to one another and relative to a specific reference point on display device 605. A locator 620 may be a light emitting diode (LED), a corner cube reflector, a reflective marker, a type of light source that contrasts with an environment in which display device 605 operates, or some combination thereof. In embodiments where locators 620 are active (e.g., an LED or other type of light emitting device), locators 620 may emit light in the visible band (e.g., about 500 nm to 750 nm), in the infrared band (e.g., about 750 nm to 1 mm), in the ultraviolet band (about 100 nm to 500 nm), some other portion of the electromagnetic spectrum, or some combination thereof.

In some embodiments, locators 620 are located beneath an outer surface of display device 605, which is transparent to the wavelengths of light emitted or reflected by locators 620 or is thin enough to not substantially attenuate the wavelengths of light emitted or reflected by locators 620. Additionally, in some embodiments, the outer surface or other portions of display device 605 are opaque in the visible band of wavelengths of light. Thus, locators 620 may emit light in the IR band under an outer surface that is transparent in the IR band but opaque in the visible band.

IMU 630 is an electronic device that generates calibration data based on measurement signals received from one or more position sensors 625. Position sensor 625 generates one or more measurement signals in response to motion of display device 605. Examples of position sensors 625 include: one or more accelerometers, one or more gyroscopes, one or more magnetometers, another suitable type of sensor that detects motion, a type of sensor used for error correction of IMU 630, or some combination thereof. Position sensors 625 may be located external to IMU 630, internal to IMU 630, or some combination thereof.

Based on the one or more measurement signals from one or more position sensors 625, IMU 630 generates first calibration data indicating an estimated position of display device 605 relative to an initial position of display device 605. For example, position sensors 625 include multiple accelerometers to measure translational motion (forward/back, up/down, left/right) and multiple gyroscopes to measure rotational motion (e.g., pitch, yaw, roll). In some embodiments, IMU 630 rapidly samples the measurement signals and calculates the estimated position of display device 605 from the sampled data. For example, IMU 630 integrates the measurement signals received from the accelerometers over time to estimate a velocity vector and integrates the velocity vector over time to determine an estimated position of a reference point on display device 605. Alternatively, IMU 630 provides the sampled measurement signals to console 610, which determines the first calibration data. The reference point is a point that may be used to describe the position of display device 605. While the reference point may generally be defined as a point in space; however, in practice the reference point is defined as a point within display device 605 (e.g., a center of IMU 630).

In some embodiments, IMU 630 receives one or more calibration parameters from console 610. As further discussed below, the one or more calibration parameters are used to maintain tracking of display device 605. Based on a received calibration parameter, IMU 630 may adjust one or more IMU parameters (e.g., sample rate). In some embodiments, certain calibration parameters cause IMU 630 to update an initial position of the reference point so it corresponds to a next calibrated position of the reference point. Updating the initial position of the reference point as the next calibrated position of the reference point helps reduce accumulated error associated with the determined estimated position. The accumulated error, also referred to as drift error, causes the estimated position of the reference point to “drift” away from the actual position of the reference point over time.

Imaging device 635 generates calibration data in accordance with calibration parameters received from console 610. Calibration data includes one or more images showing observed positions of locators 620 that are detectable by imaging device 635. In some embodiments, imaging device 635 includes one or more still cameras, one or more video cameras, any other device capable of capturing images including one or more locators 620, or some combination thereof. Additionally, imaging device 635 may include one or more filters (e.g., used to increase signal to noise ratio). Imaging device 635 is configured to optionally detect light emitted or reflected from locators 620 in a field of view of imaging device 635. In embodiments where locators 620 include passive elements (e.g., a retroreflector), imaging device 635 may include a light source that illuminates some or all of locators 620, which retro-reflect the light towards the light source in imaging device 635. Second calibration data is communicated from imaging device 635 to console 610, and imaging device 635 receives one or more calibration parameters from console 610 to adjust one or more imaging parameters (e.g., focal length, focus, frame rate, ISO, sensor temperature, shutter speed, aperture, etc.).

In some embodiments, display device 605 optionally includes one or more optical elements 660 (e.g., lenses, reflectors, gratings, etc.). In some embodiments, electronic display device 605 includes a single optical element 660 or multiple optical elements 660 (e.g., an optical element 660 for each eye of a user). In some embodiments, electronic display 615 projects computer-generated images on one or more optical elements 660, such as a reflective element, which, in turn, reflect the images toward an eye or eyes of a user. The computer-generated images include still images, animated images, and/or a combination thereof. The computer-generated images include objects that appear to be two-dimensional and/or three-dimensional objects. In some embodiments, one or more optical elements 660 are partially transparent (e.g., the one or more optical elements 660 have a transmittance of at least 15%, 20%, 25%, 30%, 35%, 50%, 55%, or 50%), which allows transmission of ambient light. In such embodiments, computer-generated images projected by electronic display 615 are superimposed with the transmitted ambient light (e.g., transmitted ambient image) to provide augmented reality images.

In some embodiments, one or more optical elements 660, or a subset there of, are positioned to modify light (e.g., ambient light) transmitted to electronic display 615. For example, the one or more optical elements 660 may include an optical dimmer to selectively reduce the intensity of light passing through the optical dimmer. In some embodiments, optical elements 660 include an optical device (e.g., 100) described above with respect to FIGS. 1A-1B, 2A-2B, 3, and 4.

Input interface 640 is a device that allows a user to send action requests to console 610. An action request is a request to perform a particular action. For example, an action request may be to start or end an application or to perform a particular action within the application. Input interface 640 may include one or more input devices. Example input devices include: a keyboard, a mouse, a game controller, data from brain signals, data from other parts of the human body, or any other suitable device for receiving action requests and communicating the received action requests to console 610. An action request received by input interface 640 is communicated to console 610, which performs an action corresponding to the action request. In some embodiments, input interface 640 may provide haptic feedback to the user in accordance with instructions received from console 610. For example, haptic feedback is provided when an action request is received, or console 610 communicates instructions to input interface 640 causing input interface 640 to generate haptic feedback when console 610 performs an action.

Console 610 provides media to display device 605 for presentation to the user in accordance with information received from one or more of: imaging device 635, display device 605, and input interface 640. In the example shown in FIG. 6, console 610 includes application store 645, tracking module 650, and application engine 655. Some embodiments of console 610 have different modules than those described in conjunction with FIG. 6. Similarly, the functions further described herein may be distributed among components of console 610 in a different manner than is described here.

When application store 645 is included in console 610, application store 645 stores one or more applications for execution by console 610. An application is a group of instructions, that when executed by a processor, is used for generating content for presentation to the user. Content generated by the processor based on an application may be in response to inputs received from the user via movement of display device 605 or input interface 640. Examples of applications include: gaming applications, conferencing applications, video playback application, or other suitable applications.

When tracking module 650 is included in console 610, tracking module 650 calibrates system 600 using one or more calibration parameters and may adjust one or more calibration parameters to reduce error in determination of the position of display device 605. For example, tracking module 650 adjusts the focus of imaging device 635 to obtain a more accurate position for observed locators on display device 605. Moreover, calibration performed by tracking module 650 also accounts for information received from IMU 630. Additionally, if tracking of display device 605 is lost (e.g., imaging device 635 loses line of sight of at least a threshold number of locators 620), tracking module 650 re-calibrates some or all of system 600.

In some embodiments, tracking module 650 tracks movements of display device 605 using second calibration data from imaging device 635. For example, tracking module 650 determines positions of a reference point of display device 605 using observed locators from the second calibration data and a model of display device 605. In some embodiments, tracking module 650 also determines positions of a reference point of display device 605 using position information from the first calibration data. Additionally, in some embodiments, tracking module 650 may use portions of the first calibration data, the second calibration data, or some combination thereof, to predict a future location of display device 605. Tracking module 650 provides the estimated or predicted future position of display device 605 to application engine 655.

Application engine 655 executes applications within system 600 and receives position information, acceleration information, velocity information, predicted future positions, or some combination thereof of display device 605 from tracking module 650. Based on the received information, application engine 655 determines content to provide to display device 605 for presentation to the user. For example, if the received information indicates that the user has looked to the left, application engine 655 generates content for display device 605 that mirrors the user's movement in an augmented environment. Additionally, application engine 655 performs an action within an application executing on console 610 in response to an action request received from input interface 640 and provides feedback to the user that the action was performed. The provided feedback may be visual or audible feedback via display device 605 or haptic feedback via input interface 640.

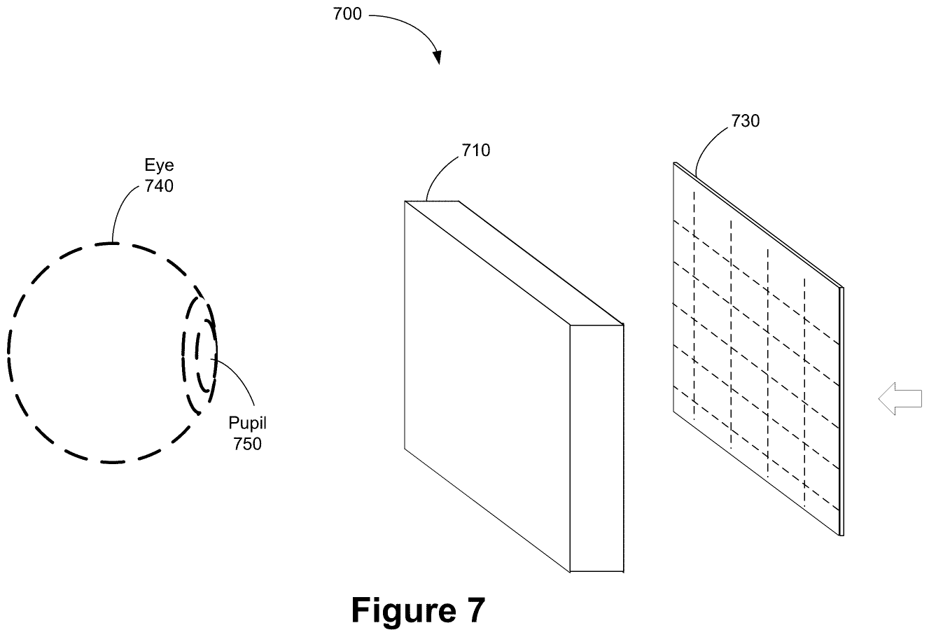

FIG. 7 is an isometric view of display device 700 in accordance with some embodiments. In some other embodiments, display device 700 is part of some other electronic display (e.g., a digital microscope, a head-mounted display device, etc.). In some embodiments, display device 700 includes light emission device 710 (e.g., a light emission device array) and an optical assembly 730, which may include one or more lenses and/or other optical components. In some embodiments, display device 700 also includes an IR detector array.

Light emission device 710 emits image light and optional IR light toward the viewing user. Light emission device 710 includes one or more light emission components that emit light in the visible light (and optionally includes components that emit light in the IR). Light emission device 710 may include, e.g., an array of LEDs, an array of microLEDs, an array of organic LEDs (OLEDs), an array of superluminescent LEDs (sLEDS) or some combination thereof.

In some embodiments, light emission device 710 includes an emission intensity array (e.g., a spatial light modulator) configured to selectively attenuate light emitted from light emission device 710. In some embodiments, the emission intensity array is composed of a plurality of liquid crystal cells or pixels, groups of light emission devices, or some combination thereof. Each of the liquid crystal cells is, or in some embodiments, groups of liquid crystal cells are, addressable to have specific levels of attenuation. For example, at a given time, some of the liquid crystal cells may be set to no attenuation, while other liquid crystal cells may be set to maximum attenuation. In this manner, the emission intensity array is able to provide image light and/or control what portion of the image light is transmitted. In some embodiments, display device 700 uses the emission intensity array to facilitate providing image light to a location of pupil 750 of eye 740 of a user, and minimize the amount of image light provided to other areas in the eyebox. In some embodiments, display device 700 includes, or is optically coupled with, electro-optic devices operating as a display resolution enhancement component. In some embodiments, display device 700 is an augmented reality display device. In such embodiments, display device 700 includes, or is optically coupled with, electro-optic devices operating as a waveguide-based combiner or as a polarization selective reflector.

In some embodiments, the display device 700 includes one or more lenses. The one or more lenses receive modified image light (e.g., attenuated light) from light emission device 710, and direct the modified image light to a location of pupil 750. The optical assembly may include additional optical components, such as color filters, mirrors, etc.

In some embodiments, the optical assembly 730 includes an optical device (e.g., 100) described above with respect to FIGS. 1A-1B, 2A-2B, 3, and 4. The optical device 100 has a variable transmittance (e.g., has a first transmittance curve at a first time and a second transmittance curve distinct from the first transmittance curve at a second time mutually exclusive from the first time). The optical device 100 conditionally reduces intensity of light passing through the optical device 100. In some embodiments, the optical device 100 has only a single window that has a uniform transmittance across the window at each time (e.g., the optical device 100 operates as a single variable intensity filter). In some embodiments, the optical device 100 has a plurality of regions, as shown in FIG. 7, where each region may have a transmittance independent of transmittances of other regions. For example, the optical device 100 may include an array of the structure shown in FIG. 1.

An optional IR detector array detects IR light that has been retro-reflected from the retina of eye 740, a cornea of eye 740, a crystalline lens of eye 740, or some combination thereof. The IR detector array includes either a single IR sensor or a plurality of IR sensitive detectors (e.g., photodiodes). In some embodiments, the IR detector array is separate from light emission device 710. In some embodiments, the IR detector array is integrated into light emission device 710.

In some embodiments, light emission device 710 including an emission intensity array make up a display element. Alternatively, the display element includes light emission device 710 (e.g., when light emission device 710 includes individually adjustable pixels) without the emission intensity array. In some embodiments, the display element additionally includes the IR array. In some embodiments, in response to a determined location of pupil 750, the display element adjusts the emitted image light such that the light output by the display element is refracted by one or more lenses toward the determined location of pupil 750, and not toward other locations in the eyebox.

In some embodiments, display device 700 includes one or more broadband sources (e.g., one or more white LEDs) coupled with a plurality of color filters, in addition to, or instead of, light emission device 710.

In light of these principles, we now turn to certain embodiments.

In accordance with some embodiments, an optical device (e.g., the optical device 100) includes a first optically dimmable switch (e.g., the first optically dimmable switch 110) for providing a first transmittance while the first optically dimmable switch is in a first state (e.g., an “on” state) and providing a second transmittance distinct from the first transmittance while the first optically dimmable switch is in a second state (e.g., an “off” state) distinct from the first state. The optical device also includes a dynamic heat source (e.g., the dynamic heat source 120) thermally coupled with the first optically dimmable switch. The dynamic heat source is at a first temperature at a first time (e.g., when the dynamic heat source is turned on) and is at a second temperature distinct from the first temperature at a second time (e.g., when the dynamic heat source is turned off) mutually exclusive from the first time.

In some embodiments, the dynamic heat source at the first temperature places the first optically dimmable switch in the first state, and the dynamic heat source at the second temperature places the first optically dimmable switch in the second state. For example, the first optically dimmable switch includes a thermochromic material and adjusting the temperature of the dynamic heat source changes the temperature of the first optically dimmable switch, thereby causing changes to the transmittance of the first optically dimmable switch.

In some embodiments, the optical device further includes a second optically dimmable switch (e.g., the second optically dimmable switch 170) that is optically coupled with the first optically dimmable switch so that a ray of light passes through the first optically dimmable switch and the second optically dimmable switch sequentially. For example, in some embodiments, the first optically dimmable switch and the second optically dimmable switch are stacked with or without an intervening layer (e.g., a layer of the thermally conductive material 130).

In some embodiments, the first optically dimmable switch includes photochromic material. For example, the photochromic material may include triarylmethanes, stilbenes, azastilbenes, nitrones, fulgides, spiropyrans, naphthopyrans, spiro-oxazines, quinones, phenoxynaphthacene quinone, diarylethenes, azobenzenes, silver halides (e.g., silver chloride), zinc halides, yttrium oxyhydride, or ruthenium sulfoxide complexes.

In some embodiments, the second optically dimmable switch includes liquid crystal.

In some embodiments, the first optically dimmable switch includes photodichroic material.

In some embodiments, the first optically dimmable switch also includes liquid crystal.

In some embodiments, the first optically dimmable switch includes carbon nanotubes.

In some embodiments, the optical device includes an array of optically dimmable switches, including the first optically dimmable switch.

In accordance with some embodiments, a head-mounted display device (e.g., 500 or 700) includes a display and (e.g., 710) an optical device (e.g., 730) that includes: a first optically dimmable switch for providing a first transmittance while the first optically dimmable switch is in a first state and providing a second transmittance distinct from the first transmittance while the first optically dimmable switch is in a second state distinct from the first state; and a dynamic heat source thermally coupled with the first optically dimmable switch. The dynamic heat source is at a first temperature at a first time and is at a second temperature distinct from the first temperature at a second time mutually exclusive from the first time.

In some embodiments, the dynamic heat source at the first temperature places the first optically dimmable switch in the first state, and the dynamic heat source at the second temperature places the first optically dimmable switch in the second state.

In some embodiments, the optical device further includes a second optically dimmable switch that is optically coupled with the first optically dimmable switch so that a ray of light passes through the first optically dimmable switch and the second optically dimmable switch sequentially.

In some embodiments, the first optically dimmable switch includes photochromic material.

In some embodiments, the second optically dimmable switch includes liquid crystal.

In some embodiments, the first optically dimmable switch includes photodichroic material.

In some embodiments, the first optically dimmable switch also includes liquid crystal.

In some embodiments, the first optically dimmable switch includes carbon nanotubes.

In some embodiments, the head-mounted display device includes an array of optically dimmable switches, including the first optically dimmable switch.

In accordance with some embodiments, a method includes: at a first time, setting a dynamic heat source thermally coupled with a first optically dimmable switch to be at a first temperature so that the first optically dimmable switch enters a first state for providing a first transmittance; and, at a second time mutually exclusive from the first time, setting the dynamic heat source to be at a second temperature distinct from the first temperature so that the first optically dimmable switch enters a second state for providing a second transmittance distinct from the first transmittance.

Changes in the optical properties of the first optically dimmable switch, activated by the dynamic heat source, may be used to enhance the performance in performance of the optical device by complementing, or compensating for, changes in optical properties triggered based on an electrical input or an optical input without thermal adjustment.

In some embodiments, the second time is subsequent to the first time. The method further includes, at a third time subsequent to the second time, setting the dynamic heat source to be at a third temperature distinct from the first temperature and the second temperature so that the first optically dimmable switch enters a third state for providing a third transmittance distinct from the first transmittance and the second transmittance.

In some embodiments, the optical device has three or more states, each state of which corresponding to a unique transmittance.

Although head-mounted displays are illustrated as apparatus that include the described optical devices, such optical devices may be used in other systems, devices, and apparatus. For example, the optical devices described herein may be used as smart windows (for buildings or vehicles) or switchable shutters.

Terms, “and” and “or” as used herein, may include a variety of meanings that are also expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AC, BC, AA, ABC, AAB, AABBCCC, etc.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, systems, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing various embodiments. Various changes may be made in the function and arrangement of elements without departing from the spirit and scope of the present disclosure.

Although various drawings illustrate operations of particular components or particular groups of components with respect to one eye, a person having ordinary skill in the art would understand that analogous operations can be performed with respect to the other eye or both eyes. For brevity, such details are not repeated herein.

Although some of various drawings illustrate a number of logical stages in a particular order, stages which are not order dependent may be reordered and other stages may be combined or broken out. While some reordering or other groupings are specifically mentioned, others will be apparent to those of ordinary skill in the art, so the ordering and groupings presented herein are not an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

What is claimed is:

1. An optical device, comprising:
a first optically dimmable switch for providing a first transmittance while the first optically dimmable switch is in a first state and providing a second transmittance distinct from the first transmittance while the first optically dimmable switch is in a second state distinct from the first state; and
a dynamic heat source thermally coupled with the first optically dimmable switch, wherein the dynamic heat source is at a first temperature at a first time and is at a second temperature distinct from the first temperature at a second time mutually exclusive from the first time.

2. The optical device of claim 1, wherein:
the dynamic heat source at the first temperature places the first optically dimmable switch in the first state, and the dynamic heat source at the second temperature places the first optically dimmable switch in the second state.

3. The optical device of claim 1, further comprising:
a second optically dimmable switch that is optically coupled with the first optically dimmable switch so that a ray of light passes through the first optically dimmable switch and the second optically dimmable switch sequentially.

4. The optical device of claim 3, wherein:
the first optically dimmable switch includes photochromic material.

5. The optical device of claim 4, wherein:
the second optically dimmable switch includes liquid crystal.

6. The optical device of claim 1, wherein:
the first optically dimmable switch includes photodichroic material.

7. The optical device of claim 6, wherein:
the first optically dimmable switch also includes liquid crystal.

8. The optical device of claim 1, wherein:
the first optically dimmable switch includes carbon nanotubes.

9. The optical device of claim 1, including:
an array of optically dimmable switches, including the first optically dimmable switch.

10. A head-mounted display device, comprising:
a display; and
an optical device that includes:
a first optically dimmable switch for providing a first transmittance while the first optically dimmable switch is in a first state and providing a second transmittance distinct from the first transmittance while the first optically dimmable switch is in a second state distinct from the first state; and
a dynamic heat source thermally coupled with the first optically dimmable switch, wherein the dynamic heat source is at a first temperature at a first time and is at a second temperature distinct from the first temperature at a second time mutually exclusive from the first time.

11. The head-mounted display device of claim 10, wherein:
the dynamic heat source at the first temperature places the first optically dimmable switch in the first state, and the dynamic heat source at the second temperature places the first optically dimmable switch in the second state.

12. The head-mounted display device of claim 10, wherein the optical device further includes:
a second optically dimmable switch that is optically coupled with the first optically dimmable switch so that a ray of light passes through the first optically dimmable switch and the second optically dimmable switch sequentially.

13. The head-mounted display device of claim 12, wherein:
the first optically dimmable switch includes photochromic material.

14. The head-mounted display device of claim 13, wherein:
the second optically dimmable switch includes liquid crystal.

15. The head-mounted display device of claim 10, wherein:
the first optically dimmable switch includes photodichroic material.

16. The head-mounted display device of claim 15, wherein:
the first optically dimmable switch also includes liquid crystal.

17. The head-mounted display device of claim 10, wherein:
the first optically dimmable switch includes carbon nanotubes.

18. The head-mounted display device of claim 10, including:
an array of optically dimmable switches, including the first optically dimmable switch.

19. A method, comprising:
at a first time, setting a dynamic heat source thermally coupled with a first optically dimmable switch to be at a first temperature so that the first optically dimmable switch enters a first state for providing a first transmittance; and,
at a second time mutually exclusive from the first time, setting the dynamic heat source to be at a second temperature distinct from the first temperature so that the first optically dimmable switch enters a second state for providing a second transmittance distinct from the first transmittance.

20. The method of claim 19, wherein:
the second time is subsequent to the first time; and
the method further includes, at a third time subsequent to the second time, setting the dynamic heat source to be at a third temperature distinct from the first temperature and the second temperature so that the first optically dimmable switch enters a third state for providing a third transmittance distinct from the first transmittance and the second transmittance.
